(19) United States
(12) Patent Application Publication
(10) Pub. No.: US 2024/0072721 A1
(43) Pub. Date: Feb. 29, 2024

(54) SOLAR MODULE RAIL COUPLINGS FOR SOLAR TRACKER

(71) Applicant: Nextracker LLC, Fremont, CA (US)

(72) Inventors: Abhimanyu Sable, Hyderabad (IN); Phani Kumar, Hyderabad (IN); Michael Starr, San Francisco, CA (US)

(21) Appl. No.: 18/454,601

(22) Filed: Aug. 23, 2023

Related U.S. Application Data
(60) Provisional application No. 63/400,608, filed on Aug. 24, 2022.

(51) Int. Cl. H02S 20/32

(52) U.S. Cl. CPC H02S 20/32

(57) ABSTRACT

A coupling system for use with a solar tracker includes a support rail including a pair of opposed flanges disposed in spaced relation to one another and defining a channel therebetween, each of the pair of opposed flanges including a respective slot defined therethrough, and a coupling clip configured to be received within each of the slots and a portion of a module rail received within the channel of the support rail, wherein the coupling clip includes a resilient finger disposed on a distal end portion configured to engage a portion of the pair of opposed flanges to inhibit proximal movement of the coupling clip and a one protrusion disposed on a proximal portion thereof configured to engage a portion of an opposite flange of the pair of opposed flanges to inhibit distal movement of the coupling clip to couple the module rail to the support rail.

### RELATED MATTERS

This application claims the benefit of U.S. Provisional Patent Application No. 63/400,608, filed Aug. 24, 2022, the entire contents of which are incorporated herein by reference.

### BACKGROUND

### Technical Field

The present disclosure relates to solar power generation systems, and more particularly, to clamps and clamping systems for securing solar modules to a support structure.

### Background of Related Art

Solar cells and solar panels are most efficient in sunny conditions when oriented towards the sun at a certain angle. Many solar panel systems are designed in combination with solar trackers, which follow the sun's trajectory across the sky from east to west in order to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length and including hundreds to thousands of individual solar modules that are mechanically coupled to support structures.

Coupling the numerous solar modules to the support structure requires a significant number of clamps or other mechanisms, each requiring a significant number of fasteners, driving up the cost of manufacturing each mechanism. As can be appreciated, assembling each of these mechanisms and securely tightening each fastener requires an enormous amount of time, contributing to increased cost and longer assembly time. The present disclosure seeks to address the shortcomings of prior tracker systems.

### BRIEF DESCRIPTION OF THE DRAWINGS

Various aspects and features of the present disclosure are described hereinbelow with reference to the drawings, wherein:

FIG. 1 is a perspective view of a solar module assembly provided in accordance with the present disclosure;

FIG. 2 is a perspective view of a solar module rail of the solar module assembly of FIG. 1;

FIG. 2A is an enlarged view of the area of detail indicated in FIG. 2;

FIG. 3 is a perspective view of a solar tracker rail provided in accordance with the present disclosure;

FIG. 4 is a side, elevation view of the solar tracker rail of FIG. 3;

FIG. 5 is a front, elevation view of the solar tracker rail of FIG. 3;

FIG. 6 is a plan view of the solar tracker rail of FIG. 3;

FIG. 7 is a perspective view of a solar tracker rail assembly provided in accordance with the present disclosure, shown coupled the solar tracker rail of FIG. 3;

FIG. 8 is a side, elevation view of the solar tracker rail assembly of FIG. 7;

FIG. 9 is a front, elevation view of the solar tracker rail assembly of FIG. 7;

FIG. 10 is a plan view of the solar tracker rail assembly of FIG. 7;

FIG. 11 is a perspective view of the solar tracker rail of FIG. 3 shown coupled to the solar module rail of FIG. 1 using a solar tracker rail clip provided in accordance with the present disclosure;

FIG. 12 is a side, elevation view of the solar tracker rail of FIG. 3 shown coupled to the solar module rail of FIG. 1 using the solar tracker rail clip of FIG. 11;

FIG. 13 is a perspective view of a solar tracker rail clip provided in accordance with the present disclosure;

FIG. 14 is a plan view of the solar tracker rail clip of FIG. 13;

FIG. 15 is a front, elevation view of the solar tracker rail clip of FIG. 13;

FIG. 16 is a side, elevation view of the solar tracker rail clip of FIG. 13;

FIG. 17 is a perspective view of another embodiment of a solar tracker rail clip provided in accordance with the present disclosure;

FIG. 18 is a plan view of the solar tracker rail clip of FIG. 17;

FIG. 19 is a front, elevation view of the solar tracker rail clip of FIG. 17;

FIG. 20 is a side, elevation view of the solar tracker clip of FIG. 17;

FIG. 21 is a perspective view of yet another embodiment of a solar tracker rail clip provided in accordance with the present disclosure;

FIG. 22 is a plan view of the solar tracker rail clip of FIG. 21;

FIG. 23 is a front, elevation view of the solar tracker rail clip of FIG. 21;

FIG. 24 is a side, elevation view of the solar tracker rail clip of FIG. 21;

FIG. 25 is still another embodiment of a solar tracker rail clip provided in accordance with the present disclosure;

FIG. 26 is a plan view of the solar tracker rail clip of FIG. 25;

FIG. 27 is a front, elevation view of the solar tracker rail clip of FIG. 25;

FIG. 28 is a side, elevation view of the solar tracker rail clip of FIG. 25;

FIG. 29 is a perspective view of another embodiment of a solar tracker rail provided in accordance with the present disclosure;

FIG. 30 is a side, elevation view of the solar tracker rail of FIG. 29;

FIG. 31 is a front, elevation view of the solar tracker rail of FIG. 29;

FIG. 32 is a plan view of the solar tracker rail of FIG. 29;

FIG. 33 is a perspective view of another embodiment of a solar tracker rail assembly provided in accordance with the present disclosure, shown coupled the solar tracker rail of FIG. 29;

FIG. 34 is a side, elevation view of the solar tracker rail assembly of FIG. 33;

FIG. 35 is a front, elevation view of the solar tracker rail assembly of FIG. 33;

FIG. 36 is a plan view of the solar tracker rail assembly of FIG. 33;

FIG. 37 is a perspective view of the solar tracker rail of FIG. 29 shown coupled to the solar module rail of FIG. 2;

FIG. 38 is a front, elevation view of the solar tracker rail of FIG. 29 shown coupled to the solar module rail of FIG. 2;

FIG. 39 is a side, cross-sectional view of the solar tracker rail of FIG. 29 shown coupled to the solar module rail of FIG. 2;

FIG. 40 is a perspective view of the solar tracker rail assembly of FIG. 7 shown coupled to the solar module assembly of FIG. 1;

FIG. 41 is a side, elevation view of the solar tracker rail assembly of FIG. 7 shown coupled to the solar module assembly of FIG. 1;

FIG. 42 is a front, elevation view of the solar tracker rail assembly of FIG. 7 shown coupled to the solar module assembly of FIG. 1;

FIG. 43 is a bottom, plan view of the solar tracker rail assembly of FIG. 7 shown coupled to the solar module assembly of FIG. 1;

FIG. 44 is a perspective view of a swing clip provided in accordance with the present disclosure;

FIG. 45 is a side, elevation view of the swing clip of FIG. 44 shown in an initial, unsecured position relative to the solar module rail of FIG. 2;

FIG. 46 is a side, elevation view of the swing clip of FIG. 44 shown in a second, secured position relative to the solar module rail of FIG. 2;

FIG. 47 is a perspective view of a pair of swing clips of FIG. 44 coupled to a torque tube clamp provided in accordance with the present disclosure;

FIG. 48 is a perspective view of still another embodiment of a solar tracker rail assembly provided in accordance with the present disclosure;

FIG. 49 is a front, elevation view of the solar tracker rail assembly of FIG. 48; and

FIG. 50 is a side, elevation view of the solar tracker rail assembly of FIG. 48 shown coupled to a pair of solar modules using a solar tracker clip provided in accordance with the present disclosure.

### DETAILED DESCRIPTION

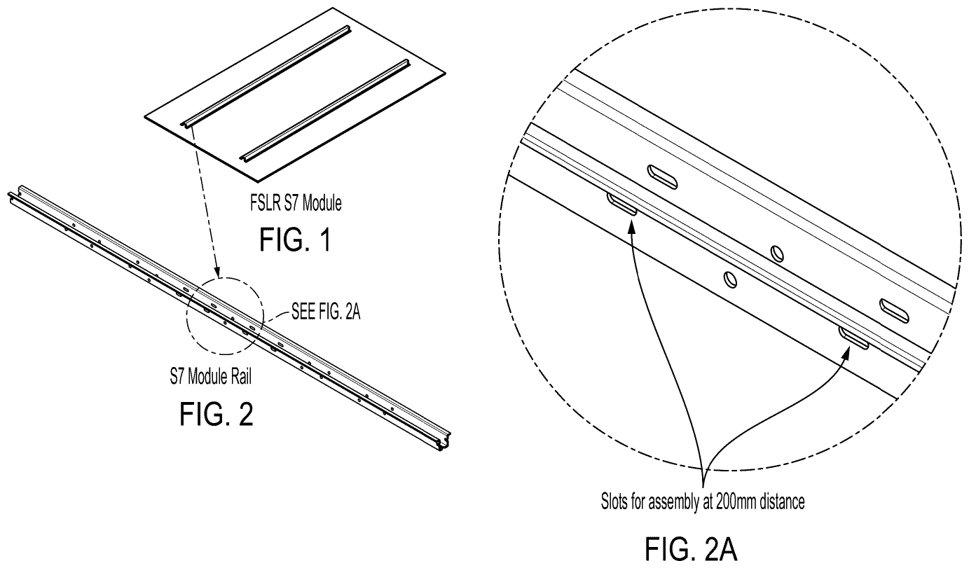

The present disclosure is directed to a coupling system for use with a solar tracker. Referring now to the drawings, FIGS. 1-2A illustrate an FSLR series-7 (S7) photovoltaic (PV) module consisting of a sheet metal frame with multiple holes and slots. These slots are used to assembly with a solar tracker mounting rail (module mounting rail) arrangement. The S7 module mounting key feature is to have a snap-fil or quick fitting between the module rail and the tracker rail without using any conventional or permanent fastening methods. Through slots are provided at 200 mm distance and 500 mm distance from the center. 2 slots or all 4 slots can be used for mounting purposes per rail.

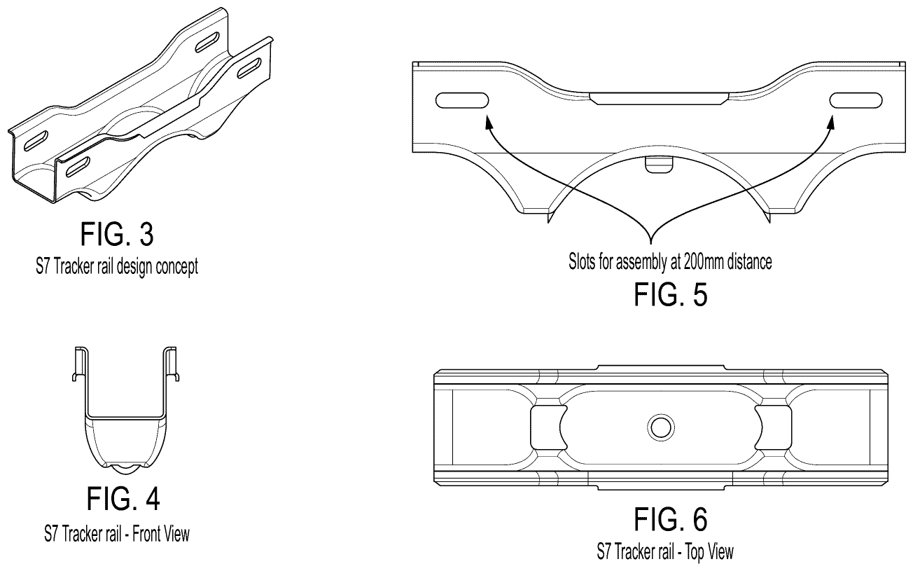

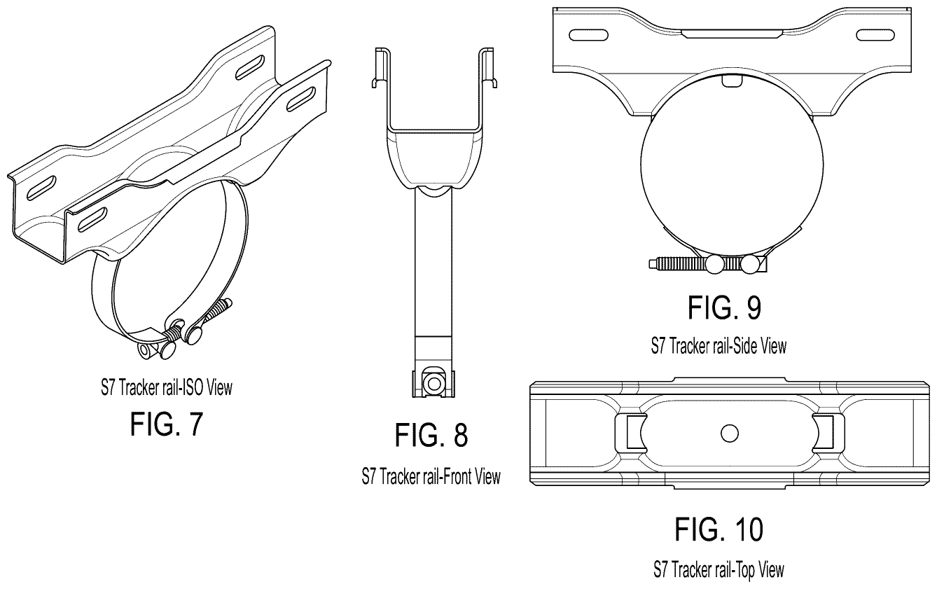

FIGS. 3-10 illustrate a tracker rail having through slots that are similar to the module hat channel. Here, a dimple with a semi-circular profile is shown for positive engagement of a torque tube and a tracker rail but a positive engagement mechanism is applicable to other profiles of the tube such as square, D-tube, Hexagon, Oval, Rectangular Hollow section (RHS), etc. Two slots that are 200 mm apart are shown for mounting but based on mounting requirements the number of slots can be expanded to 4 slots.

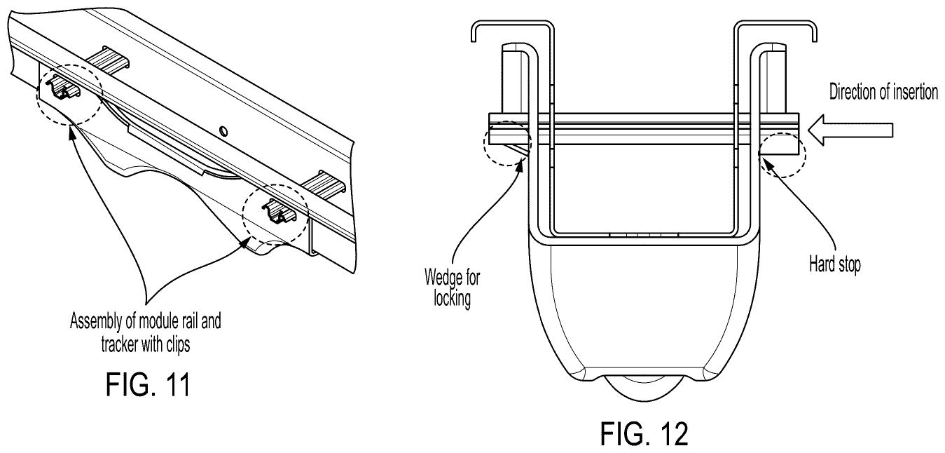

FIGS. 11 and 12 illustrate sheet metal clips for achieving a snap-fit/quick fit between the module rail and the tracker rail. The clips consist of a wedge and a hard stop. The wedge enables the passage of the clip through slots and engages in position once it is expanded due to elongation of the material. The expansion also prevents the clip from traveling in the return direction of insertion. The hard stop limits the travel of the clip to the required distance such that once it reaches the maximum distance the clip cannot travel further, and the clip is held in the required position. The wedges and hard stops on the clip can be different profiles and configurations, as will be described in further detail hereinbelow.

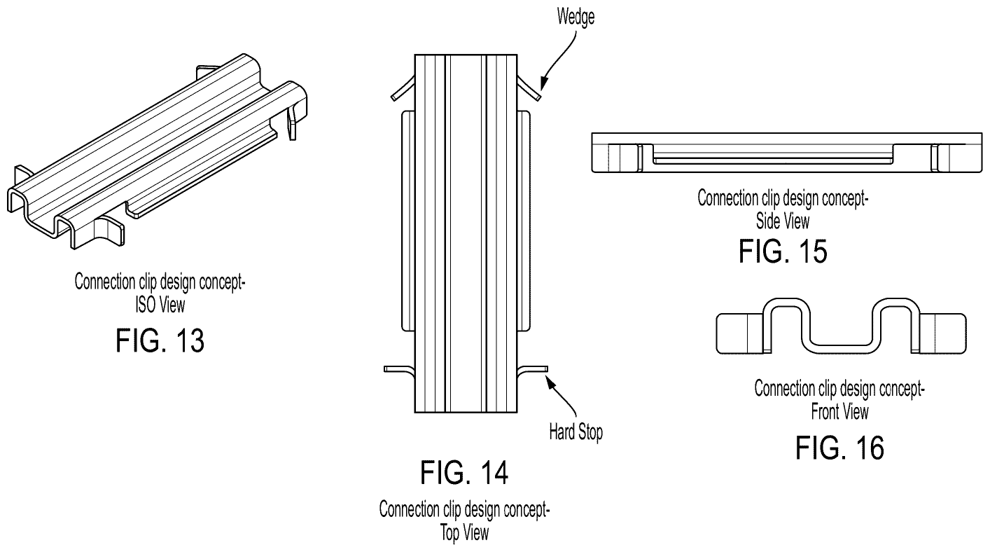

FIGS. 13-16 illustrate clips having wedges on side walls that will compress and expand. The wedges are at a 35-degree angle from the center axis. The angle may vary based on load requirements and the slot size provided on the module rail to achieve the holding capacity. The hard stop is provided on the side wall which is perpendicular to the clip's travel direction. This perpendicular hard stop prevents travel of the clip after reaching its maximum distance by interfering with the tracker rail.

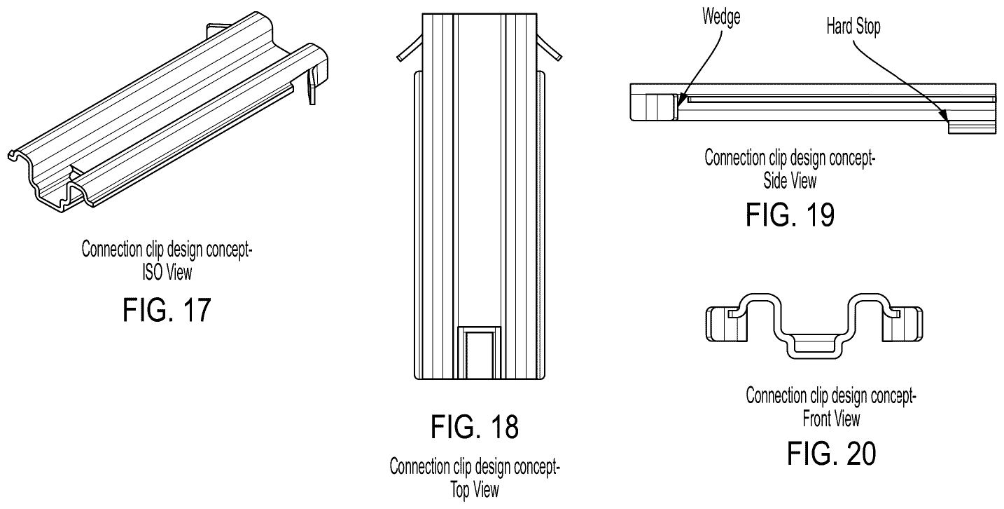

FIGS. 17-20 illustrate clips substantially similar to the clips described hereinabove with respect to FIGS. 13-16 except that the clips illustrated in FIGS. 17-20 include a hard stop formed on a lower surface and forms a vertical wall that is perpendicular to the clip's travel direction. As can be appreciated, this perpendicular hard stop prevents the travel of the clip after reaching maximum distance by interfering with the tracker rail.

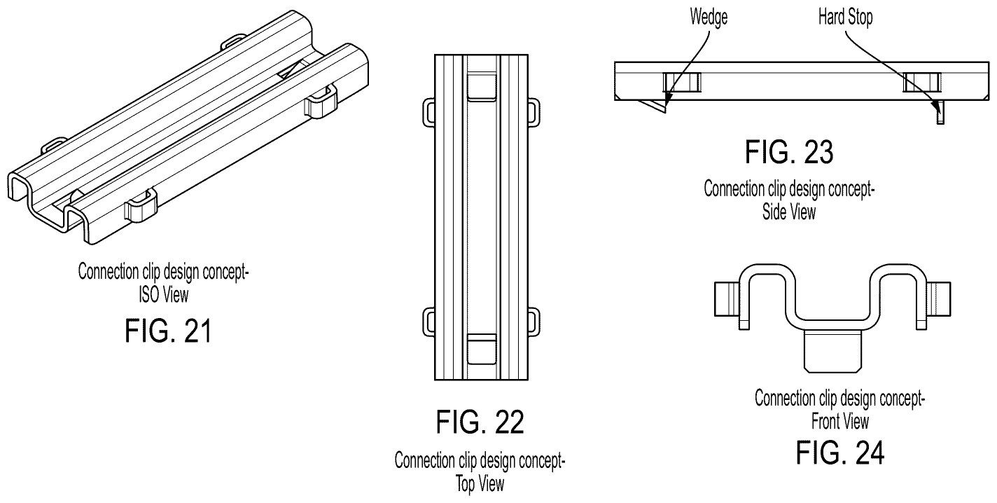

FIGS. 21-24 illustrate clips having a wedge on the bottom wall that will compress and expand. The wedge is formed at a 15-degree angle relative to the center axis and the angle may vary based on load requirements and slot sizes provided on the module rail to achieve the holding capacity. A hard stop is provided on the bottom wall which is perpendicular to the clip's travel direction. This perpendicular hard stop prevents the travel of the clip after reaching maximum distance by interfering with the tracker rail. The clips include four stiffeners on the side walls for locating purposes and preventing the clip from deviating from the required position.

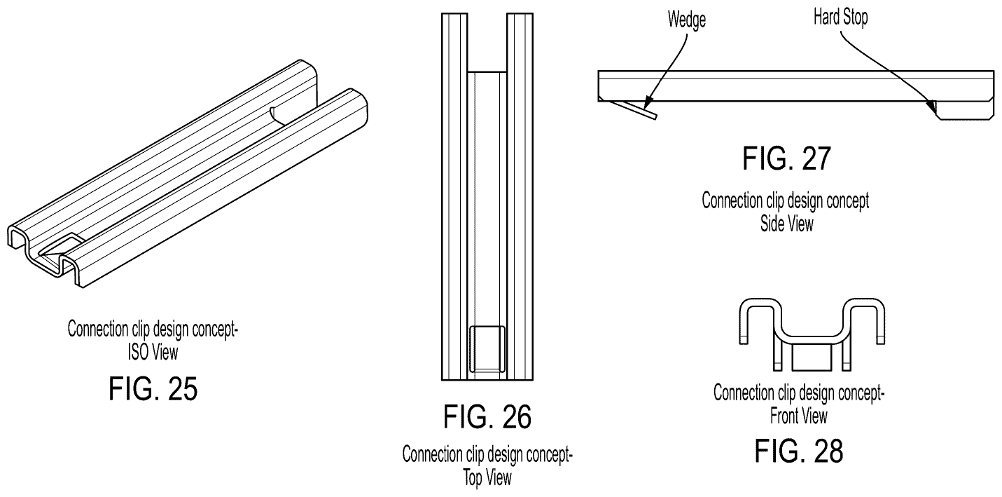

FIGS. 25-28 illustrate clips having a wedge on the bottom wall that will compress and expand. The wedge is formed at a 15-degree angle from the center axis and the angle may vary based on load requirements and the slot size provided on the module rail to achieve the holding capacity. A hard stop is provided on the bottom wall which is perpendicular to the clip's travel direction. This perpendicular hard stop prevents the travel of the clip after reaching maximum distance by interfering with the tracker rail.

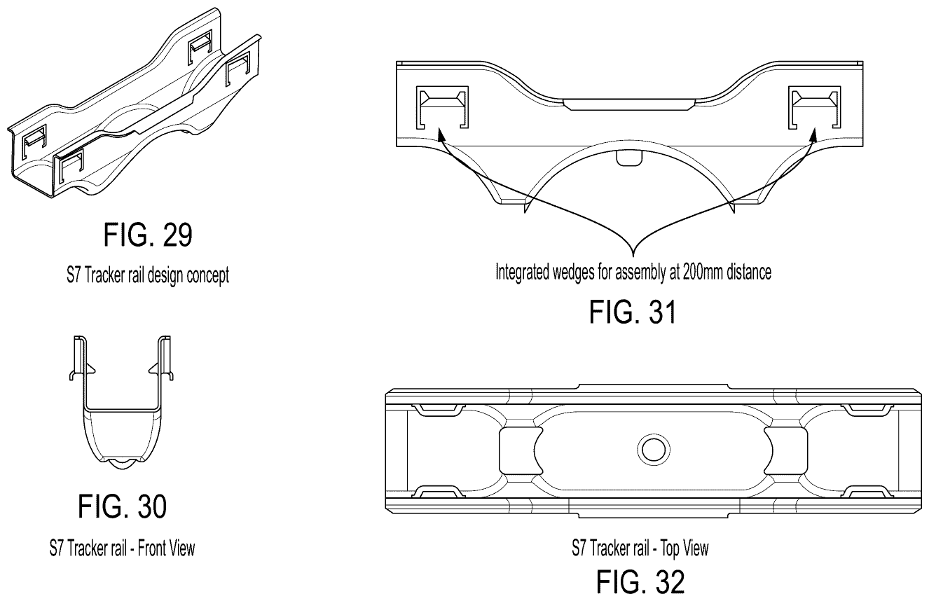

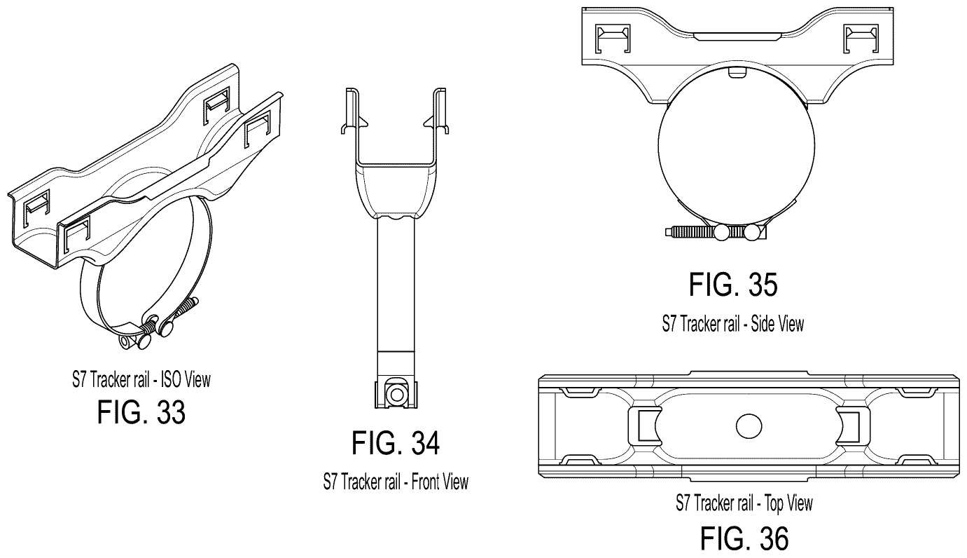

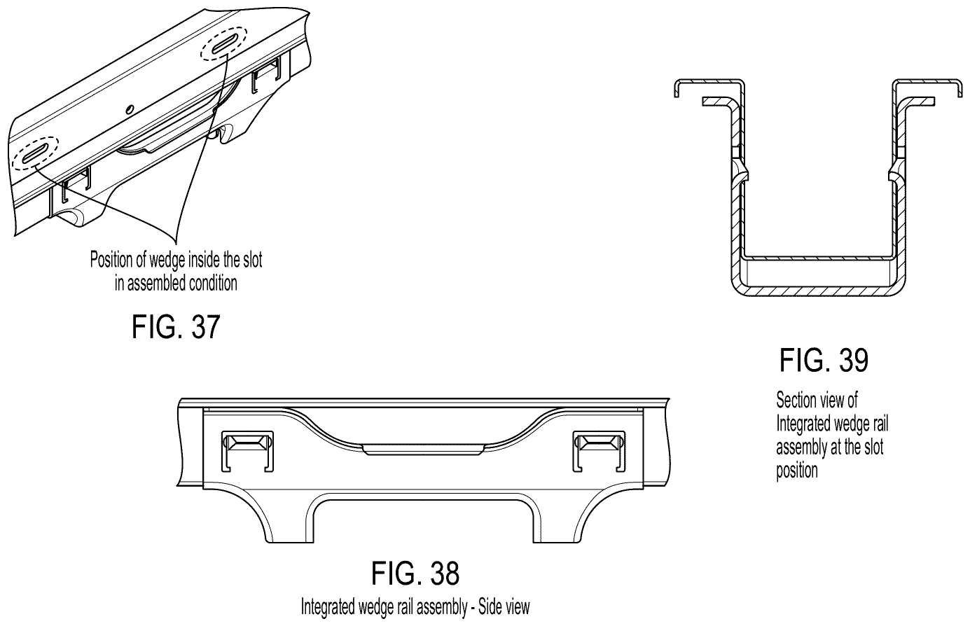

FIGS. 29-39 illustrate a tracker rail with integrated wedges that act as a hook or engagement lock when the module rail is inserted from the top of the tracker rail. This wedge expands and compresses due to stiffness provided around it by removing material. The tracker rail includes a dipole with a semi-circular profile for engagement of a torque tube but a positive engagement mechanism is applicable to other profiles of the torque tube such as square, D-tube, Hexagon, Oval, Rectangular Hollow Section (RHS), etc. The tracker rail includes two slots that are 200 mm apart for mounting but based on requirements the mounting can be expanded to four slots. The integrated wedge profile includes a semi-circular profile that accommodates the module rail. The engagement between the wedge and the module rail is illustrated in FIG. 39. The hook profile provide in the wedge prevents the module rail from traveling in an upward direction once it is engaged with the wedge. FIGS. 37-39 illustrate the tracker rail and module rail where the wedge is in a full engagement with the slots of the module rail.

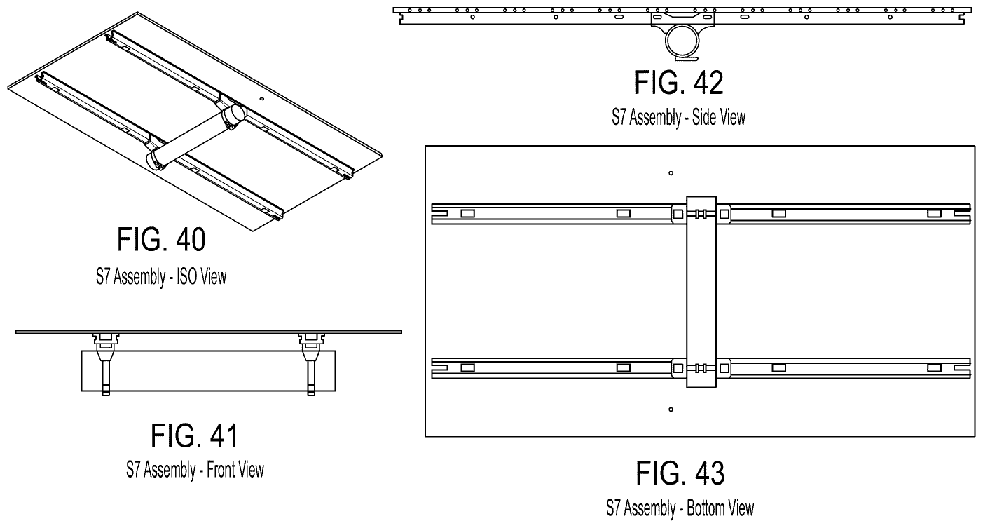

FIGS. 40-43 illustrate a solar tracker rail provided in accordance with the present disclosure coupled to solar tracker rails of a solar module assembly. The solar module rail is coupled to a torque tube using a clamp assembly that is operably coupled to a portion of the solar tracker rail.

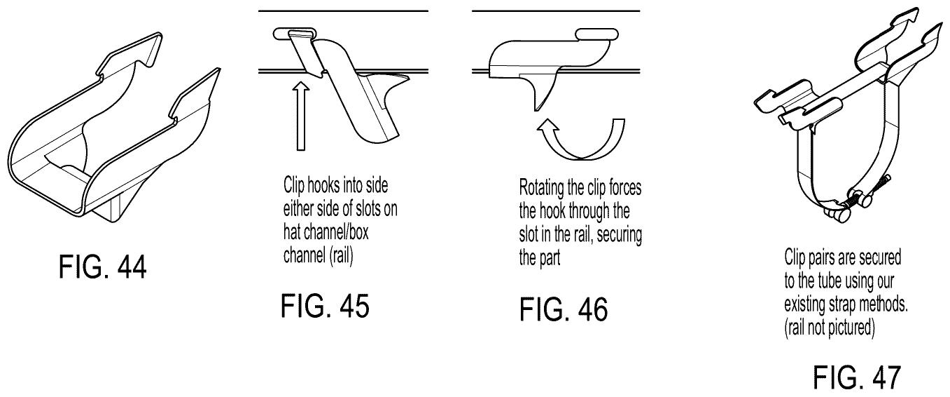

FIGS. 44-47 illustrate a swing clip provided in accordance with the present disclosure. The swing clip hooks into either side of the slots of the hat channel/box channel of the solar module rail. Rotation of the clip forces the hook through the slot in the rail and secures the clip, and therefore, a clamp assembly, to the solar module rail. In this manner, the swing clip pairs are secured to the torque tube using a strap clamp, amongst others.

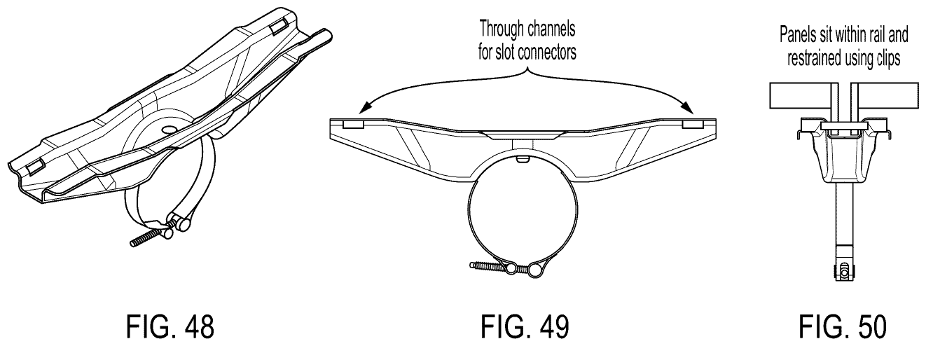

FIGS. 48-50 illustrate another embodiment of a solar tracker rail assembly having a solar tracker rail coupled to a strap clamp. The solar tracker rail includes slots formed through portions thereof for receipt of a solar tracker clip to engage one or two solar modules to the solar tracker rail. The solar modules include a frame disposed about a perimeter thereof that includes two or more slots for selective engagement with solar tracker clips to selectively couple the solar modules to the solar tracker rail assembly. In embodiments, the solar module are FSLR series 6 PV modules.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

What is claimed is:

1. A coupling system for use with a solar tracker, comprising:
a support rail including a pair of opposed flanges disposed in spaced relation to one another and defining a channel therebetween, each of the pair of opposed flanges including a respective slot defined therethrough; and
a coupling clip, the coupling clip configured to be received within each of the slots of the pair of opposed flanges and a portion of a module rail received within the channel of the support rail, wherein the coupling clip includes at least one resilient finger disposed on a distal end portion and at least one protrusion disposed on a proximal portion thereof, the at least one resilient finger configured to engage a portion of the pair of opposed flanges to inhibit proximal movement of the coupling clip and the at least one protrusion configured to engage a portion of an opposite flange of the pair of opposed flanges to inhibit distal movement of the coupling clip to selectively couple the module rail to the support rail.

2. The system of claim 1, wherein the resilient wedge finger is movable between a deployed movement inhibiting position and a retracted clip receiving position.

3. The system of claim 2, wherein the resilient wedge finger is biased to the deployed movement inhibiting position.

4. The system of claim 3, wherein the coupling clip is configured such that, as the resilient wedge finger is being received at the respective slot defined at each of the pair of opposed flanges, the bias of the resilient wedge finger is overcome to cause the resilient wedge finger to move from the deployed movement inhibiting position to the retracted clip receiving position.

5. The system of claim 4, wherein the coupling clip is configured such that as the resilient wedge finger is being received at the respective slot defined at each of the pair of opposed flanges the resilient wedge finger is at the retracted clip receiving position and when the resilient wedge finger is spaced apart from the respective slot defined at each of the pair of opposed flanges the resilient wedge finger is at the deployed movement inhibiting position.

6. The system of claim 5, wherein contact between the resilient wedge finger and each of the pair of opposed flanges at the location of the respective slot causes the bias of the resilient wedge finger to be overcome and cause the resilient wedge finger to move from the deployed movement inhibiting position to the retracted clip receiving position.

7. The system of claim 3, wherein the protrusion is non-movable relative to the coupling clip.

8. The system of claim 7, wherein the resilient wedge finger and the protrusion are configured such that the coupling clip is: (i) receivable within each of the slots of the pair of opposed flanges when the coupling clip is inserted therethrough in a direction where the resilient wedge finger leads the protrusion, (ii) prevented from reception within each of the slots of the pair of opposed flanges when the coupling clip is inserted therethrough in an opposite direction where the protrusion leads the resilient wedge finger.

9. The system of claim 8, wherein, when the resilient wedge finger is at the deployed movement inhibiting position, the resilient wedge finger extends out from a body of the coupling clip opposite the insertion direction where the resilient wedge finger leads the protrusion.

10. The system of claim 7, wherein the protrusion extends out from a body of the coupling clip a distance to create an interference stop at the protrusion between one of the slots of one of the pair of opposed flanges.

11. The system of claim 3, wherein, when the resilient wedge finger is at the deployed movement inhibiting position, the resilient wedge finger extends out from a body of the coupling clip in a direction toward the protrusion.

12. The system of claim 11, wherein, when the resilient wedge finger is at the deployed movement inhibiting position, the resilient wedge finger extends out from the distal end portion of the coupling clip at a skewed orientation so as to extend out in a direction toward the proximal end portion of the coupling clip.

13. The system of claim 1, wherein a body of the support rail defines a saddle shape that incudes a torque tube receiving recess that is configured to interface with a torque tube.

14. The system of claim 13, wherein the respective slot defined through each of the pair of opposed flanges is located between the torque tube receiving recess and a top end of each of the pair of opposed flanges.

15. A coupling system for use with a solar tracker, comprising:
a support rail including a pair of opposed flanges disposed in spaced relation to one another and defining a channel therebetween, each of the pair of opposed flanges including a respective slot defined therethrough, wherein a body of the support rail defines a saddle shape that incudes a torque tube receiving recess that is configured to interface with a torque tube, and wherein the respective slot defined through each of the pair of opposed flanges is located between the torque tube receiving recess and a top end of each of the pair of opposed flanges;
an attachment member extending out from the torque tube receiving recess, the attachment member and the torque tube recess configured to bound a perimeter of the torque tube; and
a coupling clip, the coupling clip configured to be received within each of the slots of the pair of opposed flanges and a portion of a module rail received within the channel of the support rail.

16. The system of claim 15, wherein the coupling clip includes a resilient wedge finger disposed on a distal end portion and a protrusion disposed on a proximal portion thereof, the resilient wedge finger configured to engage a portion of the pair of opposed flanges to inhibit proximal movement of the coupling clip and the protrusion configured to engage a portion of an opposite flange of the pair of opposed flanges to inhibit distal movement of the coupling clip to selectively couple the module rail to the support rail.

17. The system of claim 16, wherein the resilient wedge finger is movable between a deployed movement inhibiting position and a retracted clip receiving position, and wherein the resilient wedge finger is biased to the deployed movement inhibiting position.

18. The system of claim 17, wherein the coupling clip is configured such that as the resilient wedge finger is being received at the respective slot defined at each of the pair of opposed flanges the resilient wedge finger is at the retracted clip receiving position and when the resilient wedge finger is spaced apart from the respective slot defined at each of the pair of opposed flanges the resilient wedge finger is at the deployed movement inhibiting position.

19. The system of claim 17, wherein the protrusion is non-movable relative to the coupling clip.

20. The system of claim 19, wherein the resilient wedge finger and the protrusion are configured such that the coupling clip is: (i) receivable within each of the slots of the pair of opposed flanges when the coupling clip is inserted therethrough in a direction where the resilient wedge finger leads the protrusion, (ii) prevented from reception within each of the slots of the pair of opposed flanges when the coupling clip is inserted therethrough in an opposite direction where the protrusion leads the resilient wedge finger.
